(19) United States
(12) Patent Application Publication
(10) Pub. No.: US 2026/0171330 A1
(43) Pub. Date: Jun. 18, 2026

(54) FAST CLOSING OF A REMOTELY OPERATED CIRCUIT BREAKER

(71) Applicant: Schneider Electric USA, Inc., Andover, MA (US)

(72) Inventors: Salaheddine Faik, Marion, IA (US); Austin S. Derby, Cedar Rapids, IA (US); Chad R. Mittelstadt, Cedar Rapids, IA (US)

(73) Assignee: Schneider Electric USA, Inc., Boston, MA (US)

(21) Appl. No.: 18/980,118

(22) Filed: Dec. 13, 2024

(51) Int. Cl. H01H 3/30; H01H 3/04; H01H 3/46; H01H 33/42

(52) U.S. Cl. CPC H01H 3/30; H01H 3/04; H01H 3/46; H01H 33/42; H01H 2003/3089

(57) ABSTRACT

A circuit breaker includes a blade operable between a closed-contacts position to close the electrical contacts and an opened-contacts position to open the contacts; a kicker lever with a kicker operable to move the blade to the opened-contacts position or to release the blade from the opened-contacts position; a catch lever operable to a latched position for holding the kicker lever in the opened-contacts position and an unlatched position for unlatching and releasing the kicker lever, and thus the blade, from the opened-contacts position to the closed-contacts position; and a moveable slider operable in a first direction to move and latch the blade, via the kicker and catch levers, in the opened-contacts position and in a second direction to unlatch and release the blade from the opened-contacts position to the closed-contacts position. The catch lever (or portion thereof) is located below or under the slider or portion thereof.

### TECHNICAL FIELD

The present disclosure relates to circuit breaker, and more particularly to a system and method of fast or snap closing of the electrical contacts for a motorized circuit breaker.

### BACKGROUND

Circuit breakers can have motorized mechanisms to allow opening of the electrical contacts to open the circuit. However, in returning to the closed state, such motorized systems can include relatively slow closure which can affect performance negatively. For example. the slow closure of the contacts can cause undesirable arcing between the contacts. Furthermore, the arcing from such slow closure also can result in rapid erosion of the contacts.

### SUMMARY

In accordance with an embodiment, a circuit breaker includes a moveable blade, a moveable kicker lever, a moveable catch lever, and a moveable slider. The moveable blade includes a first electrical contact thereon or attached thereto, which is configured to make contact with a second electrical contact in a closed-contacts position and to be separated from the second electrical contact in an opened-contacts position. The moveable blade is driven by an extension spring attached to it that produces the proper contact force between the first and the second contact in the closed-contacts position. The moveable kicker lever, which includes or is connected to a kicker, is operable to engage and move the blade via the kicker to open the first and second electrical contacts when operated to the opened-contacts position or to release the blade from the opened-contacts position to allow the first and second electrical contacts to close when operated to the closed-contacts position. The moveable catch lever is operable to a latched position for catching and retaining the kicker lever in the opened-contacts position and an unlatched position for unlatching and releasing the kicker lever, which in turn releases the blade via the kicker, from the opened-contacts position to the closed-contacts position. The moveable slider includes a base and slider extension extending therefrom which includes an open end. The slider is moveable in a first direction and a second direction which is opposite the first direction. The slider movement in the first direction is accomplished via an energy storage mechanism that engages with the slider. The slider is operable: in the first direction to engage and move the kicker lever, via the open end of the slider extension, to the opened-contacts position and to cause the catch lever to move to the latched position, the catch lever or a portion thereof being arranged below or under the slider extension, and in the second direction to disengage the open end of the slider extension from the kicker lever, and after separation, to cause the catch lever to move to the unlatched position for releasing the kicker lever, which in turn releases the blade via the kicker, from the opened-contacts position to the closed-contacts position, thereby allowing the blade to snap close the first and second electrical contacts in the closed-contacts position under a force from the extension spring attached to the moveable blade. In various embodiments, the extension spring can be a toggle spring(s), and the energy storage mechanism can be a compression spring(s).

In various embodiments, the slider can be configured to move linearly along a longitudinal axis in either the first or second direction, the slider extension extending lengthwise or along the longitudinal axis from the base of the slider.

In various embodiments, the circuit breaker can further include a housing for housing components of the circuit breaker. The slider can have a first end and a second end opposite the first end, the base of the slider can be configured to be connected, directly or indirectly, to a motor at the first end, and the slider extension can extend from the base to the open end at the second end and provide an open region below the slider extension for the catch lever or portion thereof when housed in the housing.

In various embodiments, the slider extension can include an arm, which extends in a step-wise manner from the base to provide for the open region.

In various embodiments, the catch lever can be pivotable and include a pivoting end and an open end opposite the pivoting end, the open end of the catch lever being configured to catch and retain the kicker lever in the latched position when the slider is moved in the first direction.

In various embodiments, the catch lever can be biased by a biasing force to move toward the slider extension.

In various embodiments, the circuit breaker can further include a pivot pin about which the pivoting end of the catch lever pivots, the slider extension being supported or guided by the pivot pin when moving in the first or second direction.

In various embodiments, the kicker lever can include a pivoting end and an open end opposite the pivoting end, and the open end of the catch lever can be configured to engage the open end of the kicker lever in the latched position. In various embodiments, a tip of the open end of the catch lever can be configured to engage the open end of the kicker lever in the latched position.

In various embodiments, the slider extension can include first and second contact surface regions, the first contact surface region can be located on the open end of the slider extension and can be configured to engage or disengage from the kicker lever, and the second contact surface region can be located on a bottom side of the slider extension facing the catch lever or a portion thereof and can include at least a ramped surface region for engaging or disengaging from the catch lever.

In various embodiments, the catch lever can include a deflection surface region or protrusion which is configured to engage and ride along the ramped surface region of the second contact surface region of the slider extension, when the slider is moved in the second direction, to move or pivot the catch lever from the latched position to the unlatched position for unlatching and releasing the kicker lever from the opened-contacts position to the closed-contacts position.

In various embodiments, the second contact surface region of the slider extension can be configured in a predefined relationship to the first contact surface region of the slider extension by dimension and/or distance to allow for snap closing of the first and second electrical contacts, which is free from interference or influence by the slider, as the slider is operated in the second direction.

In various embodiments, the kicker lever can include a base and a kicker-lever extension which extends from the base to an open end, the catch lever can include a base and a catch extension which extends from the base to an open end, and a tip of the open end of the catch lever, which is below the open end of the slider extension, can engage the open end of the kicker lever in the latched position.

In various embodiments, when the slider is moved in the first direction, the open end of the slider extension can be configured to engage an open end of the kicker lever and move the kicker lever, which in turn moves the blade, from the closed-contacts position to the opened-contacts position.

In various embodiments, the circuit breaker can further include: a motor, operatively connected to the slider, for moving the slider in the second direction; a communication device for communicating with a remote device; and a controller configured to: receive a command from the remote device via the communication device, and in response to the command, control the motor to release the slider so it can move in the first direction to operate the blade to the opened-contacts position or move the slider in the second direction to operate the blade to the closed-contacts position.

In various embodiments, the circuit breaker is a multi-pole circuit breaker. In various embodiments, each pole of the circuit breaker can include a motorized subsystem, each of the motorized subsystems including the blade, the kicker lever and kicker, the catch lever, and the slider.

In accordance with an embodiment, an assembly is provided for a circuit breaker. The assembly includes: a moveable kicker lever, which includes or is connected to a kicker, being operable to engage and move a blade of the circuit breaker via the kicker to open electrical contacts of the circuit breaker when operated to an opened-contacts position or to release the blade from the opened-contacts position to allow the electrical contacts to close when operated to a closed-contacts position; and a moveable catch lever being operable to a latched position for catching and retaining the kicker lever in the opened-contacts position and an unlatched position for unlatching and releasing the kicker lever, which in turn releases the blade via the kicker, from the opened-contacts position to the closed-contacts position The assembly further includes a moveable slider including a base and slider extension extending therefrom which includes an open end, the slider being moveable in a first direction and a second direction which is opposite the first direction, the slider being operable: in the first direction to engage and move the kicker lever, via the open end of the slider extension, to the opened-contacts position and to cause the catch lever to move to the latched position, the catch lever or a portion thereof being arranged below or under the slider extension, and in the second direction to disengage the open end of the slider extension from the kicker lever, and after separation, to cause the catch lever to move to the unlatched position for releasing the kicker lever, which in turn releases the blade via the kicker, from the opened-contacts position to the closed-contacts position, thereby allowing the blade to snap close the electrical contacts in the closed-contacts position under a biasing force. The assembly can be a motorized assembly.

In various embodiments, the slider extension includes first and second contact surface regions, the first contact surface region is located on the open end of the slider extension and is configured to engage or disengage from the kicker lever, and the second contact surface region is located on a bottom side of the slider extension facing the catch lever or a portion thereof and comprises at least a ramped surface region for engaging or disengaging from the catch lever.

In accordance with an embodiment, a method is provided of operating an assembly for a circuit breaker. The method includes: operating a moveable kicker lever, which includes or is connected to a kicker, to engage and move a blade of the circuit breaker via the kicker to open electrical contacts of the circuit breaker when operated to an opened-contacts position or to release the blade from the opened-contacts position to allow the electrical contacts to close when operated to a closed-contacts position; and operating a moveable catch lever to a latched position for catching and retaining the kicker lever in the opened-contacts position or an unlatched position for unlatching and releasing the kicker lever, which in turn releases the blade via the kicker, from the opened-contacts position to the closed-contacts position. The method further includes operating a moveable slider including a base and slider extension extending therefrom which includes an open end, the slider being moveable in a first direction and a second direction which is opposite the first direction, the slider being operable: in the first direction to engage and move the kicker lever, via the open end of the slider extension, to the opened-contacts position and to cause the catch lever to move to the latched position, the catch lever or a portion thereof being arranged below or under the slider extension, and in the second direction to disengage the open end of the slider extension from the kicker lever, and after separation, to cause the catch lever to move to the unlatched position for releasing the kicker lever, which in turn releases the blade via the kicker, from the opened-contacts position to the closed-contacts position, thereby allowing the blade to snap close the electrical contacts in the closed-contacts position under a biasing force. The assembly can be a motorized assembly.

In accordance with various embodiments, the circuit breaker can include combinations of the features as described above and herein.

In accordance with various embodiments, a method is provided for operating or controlling operations of a circuit breaker (or an assembly/sub-assembly or assemblies/sub-assemblies thereof) such as described above and herein.

In accordance with various embodiments, a non-transient memory medium stores computer-executable code which when executed by one or more processors implements the method as described above or herein.

### BRIEF DESCRIPTION OF THE DRAWINGS

FIGS. 1 and 2 show partial opposite side views of exemplary components of a remote-controllable circuit breaker with electrical contacts in an opened-contacts position, according to embodiments of the present disclosure.

FIG. 3 shows a partial side view of exemplary components of the circuit breaker of FIGS. 1 and 2 with electrical contacts in an intermediate-opened-contacts position, according to embodiments of the present disclosure.

FIG. 4 shows a partial side view of exemplary components of the circuit breaker of FIGS. 1 and 2 with electrical contacts in a closed-contacts position, according to embodiments of the present disclosure.

FIG. 5A shows an example kicker lever of the circuit breaker of FIGS. 1-4, according to embodiments of the present disclosure.

FIG. 5B shows an example kicker of the kicker lever of the circuit breaker of FIGS. 1-4, according to embodiments of the present disclosure.

FIG. 6 shows an example catch lever of the circuit breaker of FIGS. 1-4, according to embodiments of the present disclosure.

FIG. 7 shows an example slider of the circuit breaker of FIGS. 1-4, according to embodiments of the present disclosure.

FIG. 8 is a flow chart of an example process of operating a circuit breaker between various operational positions, including an opened-contacts position and a closed-contacts position.

FIGS. 9, 10 and 11 show side views of exemplary components of the circuit breaker of FIGS. 1-4, with a portion of the blade and the electrical contacts omitted, in the opened-contacts position, the intermediate-opened-contacts position and the closed-contacts position, respectively, according to embodiments of the present disclosure.

### DETAILED DESCRIPTION OF EXAMPLE EMBODIMENTS

This description and the accompanying drawings illustrate exemplary embodiments of the present disclosure and should not be taken as limiting, with the claims defining the scope of the present disclosure, including equivalents. Various mechanical, compositional, structural, electrical, and operational changes may be made without departing from the scope of this description and the claims, including equivalents. In some instances, well-known structures and techniques have not been shown or described in detail so as not to obscure the disclosure. Further, elements and their associated aspects that are described in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment.

In accordance with embodiments of the present disclosure, a system and method are provided for implementing a circuit breaker which can protect a circuit(s) on an electrical system. The circuit breaker can include at least a pair of electrical contacts, which can be operated to open the contacts in an opened-contacts position to interrupt the flow of electrical energy to the protected circuit and to close the contacts in a closed-contacts position to allow the flow of electrical energy to the protected circuit. The circuit breaker also can include a moveable blade and an extension spring (e.g., a toggle spring, spring(s), resilient member(s), or other spring or mechanism). The blade can carry at least one of the pair of electrical contacts. The extension spring can provide a biasing force for biasing the blade, when unlatched or released, to the closed-contacts position. The system and method also can include a motorized subsystem, which is configured to provide for fast closing of the electrical contacts of the circuit breaker. The motorized subsystem can include a kicker lever with a kicker, a catch lever, a slider and a motor, which cooperate to facilitate the opening or closing of the contacts of the circuit breaker. The catch lever or portion thereof can be arranged below or under the slider (or a portion thereof). The handle assembly, kicker, and/or portion of the blade, which is engaged by the kicker, can be located above the slider (or portion thereof).

The slider can be operated, via the motor, to be released and moved in a first direction under the force from an energy storage mechanism to interact with the kicker lever and the catch lever to cause the blade to be operated to the opened-contacts position with the contacts in the open position (or state). The energy storage mechanism can include a compression spring(s) or other energy storage mechanism. When operated to the opened-contacts position, the kicker of the kicker lever can engage and retain (or hold) the blade in a position in which the contacts are open and the extension spring for the blade has reached an armed position. The kicker lever and the kicker are retained or latched in the opened-contacts position by the catch lever in a latched position (or state).

To close the contacts, the slider can be operated, via the motor, in a second direction to cause the blade to be operated to the closed-contacts position with the contacts in the closed position (or state). For example, the slider can be operated in the second direction, which can be opposite the first direction, to disengage and separate from the kicker lever, and after separation, to cause the catch lever to unlatch and release the kicker lever, and thus the blade, from the latched position. Once released, the blade can snap-close the contacts under the force of (or supplied by) the extension spring (e.g., a toggle spring(s)) to provide for a fast closing operation of the contacts of the circuit breaker.

Accordingly, the system and method of the present disclosure can provide a motorized subsystem with a fast closing feature, which can allow the circuit breaker to close the electrical contacts without arcing or with minimal/reduced arcing, thereby achieving a reliable and durable performance during normal operation and/or overload testing of the circuit breaker. The system and method also can provide a fast closing configuration, with lower sensitivity to tolerances that is easier to implement on a multi-pole circuit breaker where synchronizing multiple poles can make it difficult to achieve a consistent performance. Lower sensitivity to tolerances can mean lower production cost, higher quality product and, optimal production throughput.

In various embodiments, the catch lever (or portion thereof) can include a deflection surface region, which is configured to interact with the slider (or portion thereof), to operate and move the catch lever to different selected positions (or states), e.g., an undeflected position and a deflected position. For example, the catch lever can be configured to retain and latch the kicker lever (and thus the blade) in the opened-contacts position when in the undeflected state and to unlatch and release the kicker lever (and thus the blade) from the opened-contacts position to allow for snap closing of the contacts in the closed-contacts position when in the deflected position.

In various embodiments, the slider (or a portion thereof) can include a first contact surface region for interacting with the kicker lever, and a second contact surface region for interacting with the deflection surface region of the catch lever. The first contact surface can be located on an open-end of a portion of the slider, such as for example on an open-end of an extension (or extending portion) of the slider. The second contact surface can be located on a bottom of the slider or portion thereof, such as for example on a bottom of an extension (or extending portion) of the slider. In various embodiments, the second contact surface can include at least a ramping or ramp-shaped region.

In various embodiments, the kicker lever can include a base and an extension (also referred to as “kicker-lever extension”) which extends from the base to an open end. The catch lever can also include a base and an extension (also referred to as “catch extension” or “catch-lever extension”). In the latched state, the open-end of the catch extension of the catch lever can engage the open end of the kicker-lever extension of the kicker lever, in order to retain the kicker lever and associated kicker, as well as the blade, in the opened-contacts position.

In various embodiments, the slider can include a base and an extension (also referred as “slider extension”) which extends from the base to an open end. The slider extension can extend in a lengthwise manner from the base as an inclined or stepped extension, with an open region or space below the slider extension for the catch lever or a portion thereof. The motor can be configured to be operatively connected or coupled to the base of the slider, and the open end of the slider extension can be configured to interact with the kicker lever.

In various embodiments, the catch lever can be positioned to act on the open end (e.g., a tip) of the kicker lever far away from the kicker-lever axis. Such a configuration can have substantially reduced sensitivity to tolerances since a small linear error in the contact zone between the catch lever and the kicker lever results in a very small angular error in the kicker lever position and consequently the moveable blade angular position.

These and other example systems and methods or other features and benefits of the present disclosure are shown and/or described below and in the attached figures.

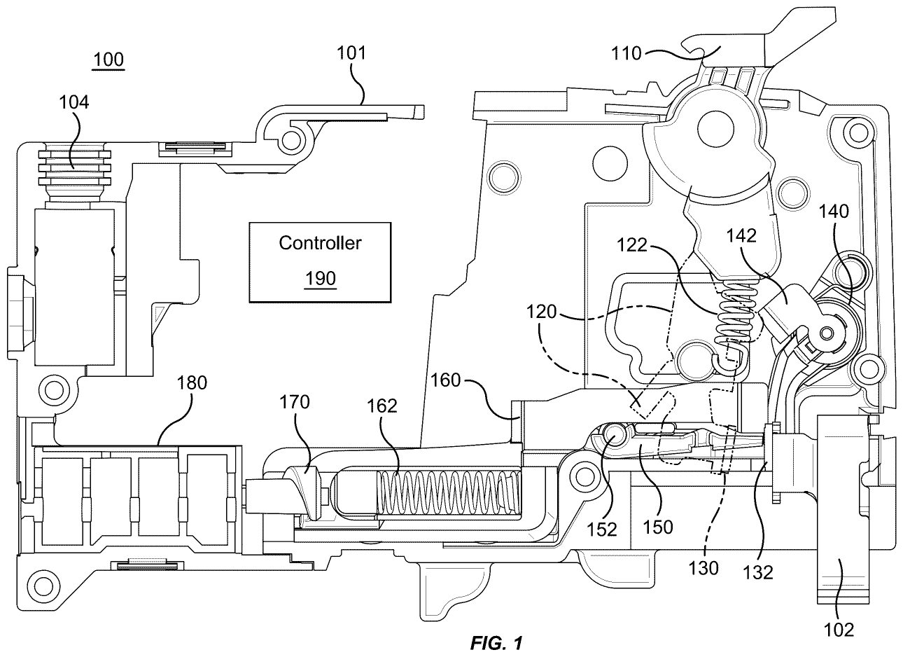

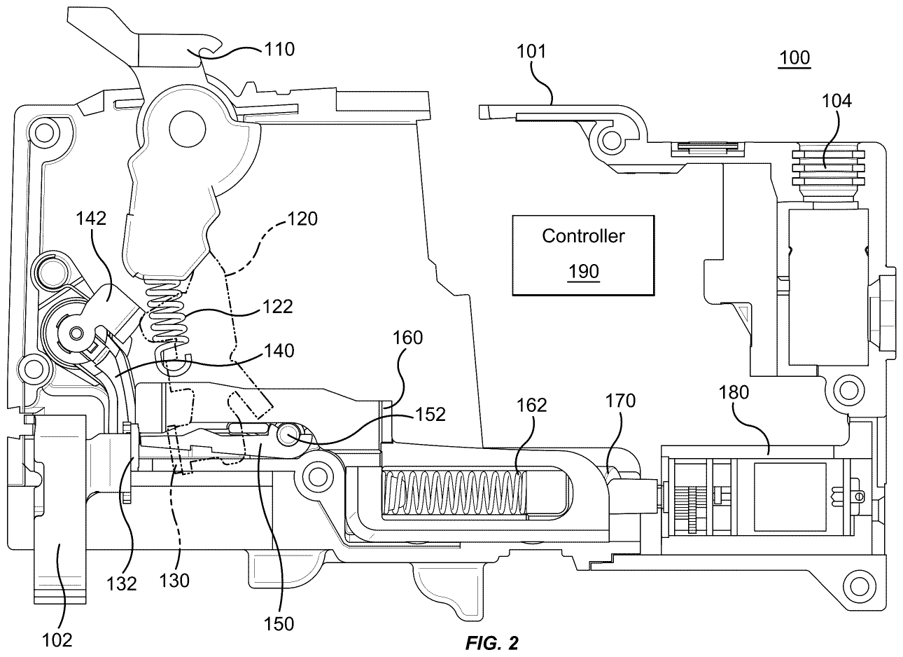

FIGS. 1 and 2 illustrate opposite partial side views of example components of a circuit breaker 100 with a portion of the housing (or case) 101 omitted, according to embodiments of the present disclosure. The circuit breaker 100 includes electrical terminals 102 and 104, electrical conductor(s) connected between the terminals 102 and 104, a handle (or assembly thereof) 110, and a moveable blade 120. The circuit breaker 100 also includes electrical contacts, such as for example a first electrical contact 130 and a second electrical contact 132. In this example, the first electrical contact 130 is carried on the blade 120 and electrically connected to the terminal 104 (not shown) across electrical conductor(s), and the second electrical contact 132 is fixed and electrically connected to the terminal 102 across electrical conductor(s). The electrical contacts 130, 132 can be closed to enable the flow of electrical energy (e.g., current, power, etc.) from an upstream power supply, between the terminals 102, 104 and across the protected circuit in the closed-contacts position, and can be opened or separated to disable or interrupt the flow of electrical energy between the terminals 102, 104 and across the protected circuit in the opened-contacts position. The handle 110, which is connected to the blade 120, can be operated to move the blade 120 at least between the closed-contacts position (with the contacts 130, 132 engaged) or the opened-contacts position (with the contacts 130, 132 separated), as well as to other positions (e.g., RESET, etc.).

The blade 120 and the first electrical contact 130 are shown generally in outline, broken-line form in FIGS. 1 and 2 to show components in the vicinity of the blade 120 and contact 130 in greater clarity. In the example of FIGS. 1 and 2, the blade 120 and the contacts 130, 132 are shown in the opened-contacts position, and can be biased to the closed-contacts position, under the force of (or supplied by) an extension spring. In this example, the extension spring is a toggle spring(s) 122 but can take the form of other type of spring(s) or resilient component(s) or other mechanism suitable for providing a biasing force to enable snap closing of the blade 120, and thus, the contacts 130, 132 when the blade 120 is released from the opened-contacts position.

In accordance with embodiments of the present application, the circuit breaker 100 also can include a motorized subsystem for controlling the operations of the blade 120 between various positions (or states), such as for example the opened-contacts position and the closed-contacts position. The motorized subsystem can be controlled to operate according to local commands or remote commands (e.g., remote control), or according to detected conditions including those on the circuit protected by the circuit breaker 100 or on the circuit breaker 100. The motorized subsystem is configured to provide for fast or snap closing of the contacts 130, 132 when the blade 120 is operated or released from the opened-contacts position to the closed-contacts position, thereby reducing, minimizing or preventing arcing when closing the contacts 130, 132 of the circuit breaker 100.

In this example, the motorized subsystem can include a kicker lever 140 with a kicker 142, a catch lever 150, a slider 160 and a motor 180 or assembly thereof (which is operatively coupled or connected to the slider 160). These components of the subsystem can cooperate to control operation of the blade 120 of the circuit breaker 100 between various positions (or states), including at least the opened-contacts position and the closed-contacts position. In various embodiments, the motorized subsystem can be controlled by a controller 190 to operate between the various positions according to local command(s), remote command(s) or other conditions (including conditions detected on the protected circuit or the circuit breaker using one or more sensors).

The kicker lever 140 can include or have connected thereto the kicker 142, and can be configured to move between a plurality of positions (or states). In this example, the kicker lever 140 can be configured to be pivotable or rotatable about a point on a base of the kicker lever 140. The kicker lever 140 can be configured to move between the opened-contacts position in which the kicker 142 engages and moves the blade 120 to open the contacts 130, 132, and the closed-contacts position in which the kicker 142 is disengaged from the blade 120 to allow the released blade 120 to snap and close the contacts 130, 132 under the force of the extension spring (e.g., the toggle spring 122). In various embodiments, the kicker 142 can be formed as a separate components which is connected or attached to the kicker lever 140, or can be integrally formed as part of the kicker lever 140.

In various embodiments, the kicker lever 140 can include a pivoting end and an open end opposite the pivoting end.

The catch lever 150 can be moveable between various positions, including at least a latched position for latching or retaining the blade 120 in the opened-contacts position and an unlatched position for unlatching or releasing the blade 120 from the opened-contacts position. For example, in the latched position, the catch lever 150 can be configured to catch and retain (or hold) the kicker lever 140 and associated kicker 142, and thus the blade 120, in the opened-contacts position. In the unlatched position, the catch lever 150 can be configured to unlatch and release the kicker lever 140 and associated kicker 142, and thus the blade 120, from the opened-contacts position, thereby allowing the released blade 120 to snap and close the contacts 130, 132 under the force of the extension spring (e.g., a toggle spring 122). In this example, the catch lever 150 can be biased (e.g., spring-biased) to move in the direction of the latched position.

In various embodiments, the catch lever 150 can be pivotable and include a pivoting end and an open end opposite a pivoting end. The open end of the catch lever 150 can be configured to catch and retain the kicker lever 140 in the latched position. For example, the open end of the catch lever 150, which can be a tip of the open end, can be configured to engage an open end of the kicker lever 140 in the latched position. In various embodiments, the tip of the open end of the catch lever 150 can be below or under the slider 160 or portion thereof (e.g., a slider extension) in the latched position. In various embodiments, the catch lever also can be biased by a biasing force (e.g., spring-biased, etc.) to move toward the slider 160 or a portion thereof (e.g., a slider extension).

Furthermore, in various embodiments, the catch lever 150 can be configured to pivot about a pivot pin 152, which is located at the pivoting end of the catch lever 150. The pivot pin 152 can be configured to support and/or guide the slider or portion thereof (e.g., a slider extension) when moving in the first or second direction.

The slider 160 can include an elongated body with an extension, which can extend along a longitudinal axis of the slider 160. The extension of the slider (also referred to as “slider extension”) can have an open end, and can be positioned over or above the catch lever 150 or a portion thereof. The slider 160 can be configured to move in a first direction to contact the kicker lever with a first contact surface region on the open-end and cause the blade 120 via the kicker 142 to be operated to the opened-contacts position for retention by the catch lever 150 in the latched position. When commanded to move to the opened-contacts position, the slider 160 is released by the worm gear 170 and moves quickly in the first direction under the energy stored in the compression spring 162. The slider 160 is further configured to move in a second direction to cause the blade 120 to be operated to the closed-contacts position. The second direction can be a direction, which is opposite the first direction. When moved in the second direction, the slider 160 can be configured to separate from the kicker lever 140 which is engaged to the catch lever 150 in the latched position, and after separation, to contact and move the catch lever 150 via a second contact surface region of the slider extension to unlatch and release the kicker lever 140 (and thus the kicker 142 and blade 120) from the opened-contacts position. When unlatched and released, the blade 120 can snap-close the first and second electrical contacts 130, 132 to the closed-contacts position under the force of the extension spring (e.g., the toggle spring 122).

In various embodiments, the slider 160 can have an extension which extends from a base to an open end and provide an open region below the slider extension for the catch lever 150 or portion thereof when housed in the housing 101.

The motor 180 or assembly thereof can be coupled or connected, directly or indirectly, to the slider 160. For example, the motor 180 can be coupled or connected to the slider 160, using or across a gear box or gearing assembly which can be configured according to the application, space requirements, and other factors including to those herein. In this example, the motor 180 is coupled or connected to the slider 160, across at least a gear 170 (e.g., a worm gear). In various embodiments, the motor 180 can be operated or controlled, such as by or under control of the controller 190, to cause the slider 160 to move in the first direction to operate the components of the circuit breaker 100 to the opened-contacts position, and in the second direction to operate the components of the motorized subsystem of the circuit breaker 100 to the closed-contacts position.

The controller 190 can be a main or primary controller or one of a plurality of controllers of the circuit breaker 100 for controlling the operations of the breaker (including the operations described herein). In addition to the controller 190, the circuit breaker 100 also can include memory, wireline and/or wireless communication interface(s)/device(s) (e.g., transmitter(s)/receiver(s), etc.) for communicating with other devices or systems, sensor(s) for sensing or monitoring conditions on the protected circuit and/or circuit breaker (e.g., diagnostic conditions, fault or overload conditions, etc.), and other components or devices for facilitating or implementing the various methods and systems described herein.

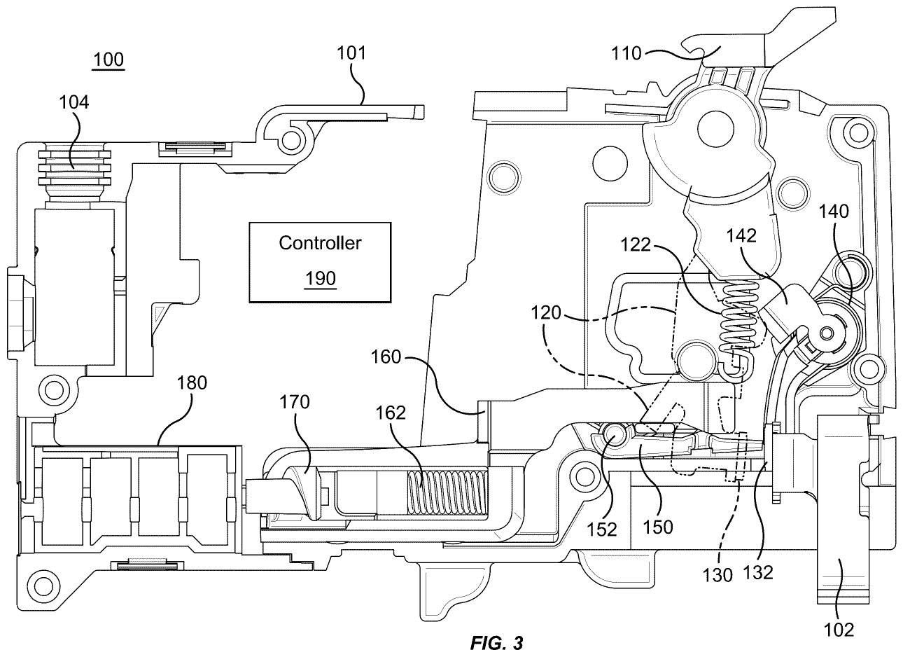

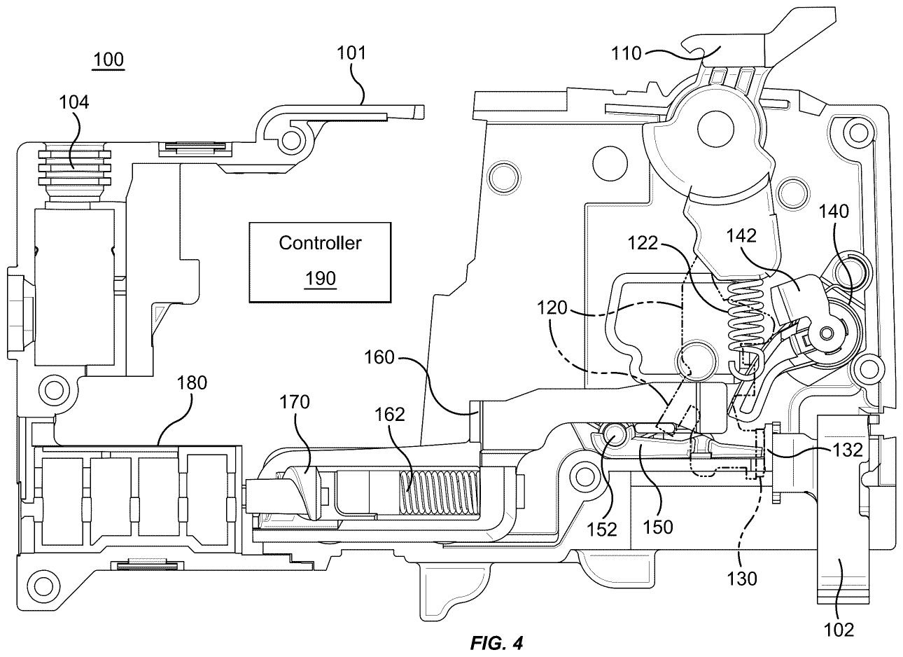

In various embodiments, the circuit breaker 100 can be a remote controllable circuit breaker. As previous discussed above, the example of FIGS. 1 and 2 show the circuit breaker 100 or components thereof, such as the blade 120, the contacts 130, 132, the kicker lever 140 with the kicker 142, the catch lever 150 and the slider 160, in the opened-contacts position. FIGS. 3 and 4 show the circuit breaker 100 or components thereof, including the contacts 130, 132, in the intermediate opened-contacts position and the closed-contacts position, respectively.

The various components of the motorized subsystem, such as the kicker lever 140, kicker 142, catch lever 150, and slider 160, can be formed of non-electrically conductive material(s) (e.g., plastic, etc.), suitable for use in a circuit breaker. The various moveable components of the motorized subsystem, such as the kicker lever 140, catch lever 150 and slider 160 can be movably mounted to the housing, internal wall(s) or other components of the circuit breaker 100. The housing (or casing) of the circuit breaker 100 as well as internal wall(s) also can be formed of a non-electrically conductive material(s), e.g., plastic, etc.

In various embodiments, the circuit breaker 100 can be a single or multi-pole circuit breaker. For a multi-pole circuit breaker, a motorized subsystem can for example be provided for each pole, and the opening or closing operations of the contacts for the poles can be synchronized under the control of one or more controllers (e.g., controller(s) 190). Alternatively or in addition thereto, in multi-pole circuit breaker, one or more of the components of the motorized subsystem(s) may be linked to synchronize movement thereof, when performing the opening or closing operations of the contacts.

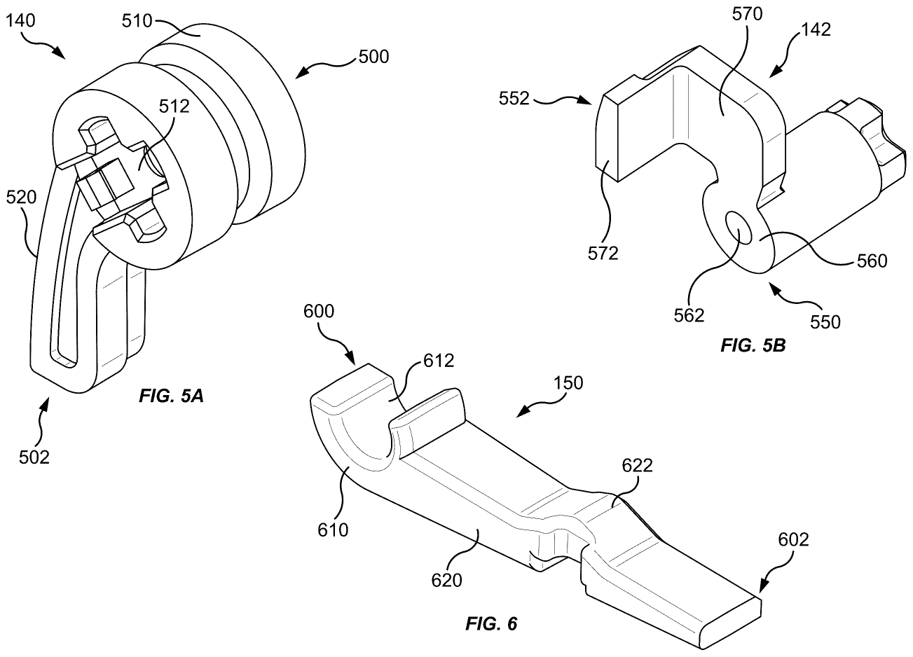

FIG. 5A shows an example kicker lever 140 of the circuit breaker 100 of FIGS. 1-4, according to embodiments of the present disclosure. As shown, the kicker lever 140 has a first end 500 and a second end 502. The kicker lever 140 includes a base 510 on the first end 500. The base 510 includes a cavity 512 for connecting the kicker 142 thereto, and for movably mounting/connecting the kicker lever 140 to a component(s) of the circuit breaker 100, such as the housing, internal wall(s) or other fixed component(s). In various embodiments, the base 510 of the kicker lever 140 can have one side or opposing sides connected, via pin(s) or the like, to such component(s) of the circuit breaker 100. Alternatively, the base 510 or portions thereof (e.g., side portion(s)) can be movably engaged in a cavity (e.g., a pocket(s)) in such component(s) of the circuit breaker 100. The kicker lever 140 also includes a kicker lever extension 520 (e.g., extending arm, extending leg, extending member, etc.) that extends from the base and terminates at an open end at the second end 502.

The kicker lever 140 is configured to pivot or rotate about a point on the base 510 between various positions. For example, the kicker lever 140 can be operated in one direction to move toward the blade 120 (or portion thereof) in order to operate the blade 120 to the opened-contacts position, and can be operated in an opposite direction away from the blade 120 (or portion thereof) in order to release the blade 120 and to allow the blade to move to the closed-contacts position. In various embodiments, the blade 120 is biased to move toward the closed-contacts positions, such as via a force supplied by an extension spring. In this example, the extension spring can take the form of the toggle spring(s) 122 but can take the form of other types of spring(s) or resilient member(s)/component(s) which, when armed or in the armed state, can provide suitable force for snap closing of the contacts 130, 132 when the blade 120 is unlatched and released from the opened-contacts position to the closed-contacts position.

FIG. 5B shows an example kicker 142 of the kicker lever 140 of the circuit breaker 100 of FIGS. 1-4, according to embodiments of the present disclosure. In this example, the kicker 142 is connectable to the kicker lever 140. As shown, the kicker 142 can have a first end 550 and a second end 552. The kicker 142 includes, at the first end 550, a base 560 which is configured to be connected or attached to the base 510 of the kicker lever 140. The base 560 (or portion(s) thereof) can be designed with a dimension (e.g., size, shape, etc.) for suitable connection within the cavity 512 of the base 510 of the kicker lever 140. Furthermore, the kicker 142 includes a kicker extension 570 which extends from the base 560 and terminates at an open-end at the second end 552. In this example, the kicker extension 570 can be an extending arm, extending leg, or other extending member, and can take the form of a hammer (e.g., hammer-shape) or the like, with a contact surface 572 at the open end. The kicker 142 or its contact surface 572 is configured to engage the blade 120 (or portion thereof) when the kicker lever 140 is operated in a direction to open the contacts 130, 132 in the opened-contacts position, and is configured to disengage from the blade 120 (or portion thereof) when the kicker lever 140 is operated in an opposite direction to close the contacts 130, 132 in the closed-contacts position.

Although the kicker 142 can be formed as a separate component(s) for connection to the kicker lever 140, it is understood that, in other embodiments, the kicker 142 can be integrally formed as part of the kicker lever 140 or as a unitary-or single-piece. In various embodiments, the kicker lever 140 and kicker 142 can be mounted to pivot at a pivot point 562, via a pivot pin(s) or the like.

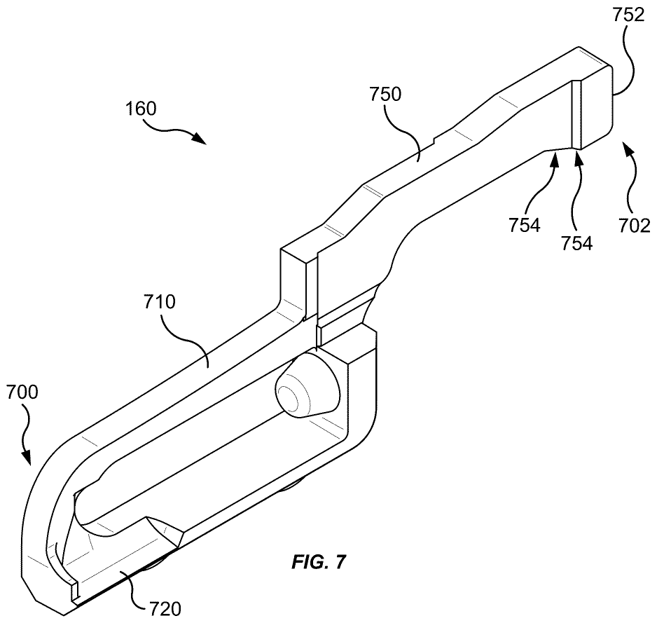

FIG. 6 shows an example catch lever 150 of the circuit breaker 100 of FIGS. 1-4, according to embodiments of the present disclosure. As shown, the catch lever 150 can include a first side 600 and a second side 602 which can be opposite the first side 600. The catch lever 150 can include a base 610 at the first side 600. The base 610 includes a cavity (or slot/groove) 612 for movably connecting the catch lever 150 to a component(s) of the circuit breaker 100, such as a housing, internal wall(s) or a fixed component(s) of the circuit breaker 100. In various embodiments, the base 610 of the catch lever 150 can be movably connected, via pin(s) or the like, to such component(s) of the circuit breaker 100 or via other movable connection configurations.

Furthermore, the catch lever 150 also can include a catch extension 620 (e.g., extending arm, extending leg, extending member, etc.) which extends from the base 610 to an open end at the second side 602. The catch extension 620 can include a deflection surface 622, which in this example can take the form of a protruding or raised surface region (e.g., protrusion, etc.). The catch lever 150 can be operated from an undeflected position (or state) to a deflected position by applying a suitable force to the deflection surface region 622 of the catch lever 150. In this example, the catch lever 150 is biased toward the undeflected position.

The catch lever 150 can be movably operated between at least a latched position and an unlatched position, for example depending on whether the catch lever 150 is in the undeflected or deflected position, respectively. In various embodiments, the catch lever 150 can be configured to pivot or rotate about a point on the base 610. In the latched position, the catch lever 150 is configured to catch and retain the kicker lever 140 in the opened-contacts position, when the blade 120 is operated from the closed-contacts position to the opened-contacts position. For example, in the latched position, the open-end of the catch extension 620 engages the kicker lever extension 520 to catch and retain the kicker lever 140 in the opened-contacts position (see, e.g., FIGS. 1 and 2). In the unlatched position, the catch lever 150 is configured to unlatch and release the kicker lever 140, and thus, the blade 120 from the opened-contacts position to allow for snap closing of the blade 120 to close the contacts 130, 132 in the closed-contacts position. For example, in the unlatched position, the catch lever 150 is deflected to the deflected state, via the deflection surface region 622, to disengage the open end (e.g., tip) of the catch extension 620 from the open end (e.g., tip) of the kicker lever extension 520, thereby unlatching and releasing the kicker lever 140, and thus, the kicker 142 and the blade 120 from the opened-contacts position. When the kicker lever 140 is released, the blade 120 is free to move, thereby allowing snap-closing of contacts 130, 132 by the blade 120 in the closed-contacts position, under the force of the extension spring.

The size/dimension and/or location of the deflection surface region 622 along the catch extension 620 can be configured to ensure sufficient clearance between the slider 160 and the kicker lever 130 before the catch lever 150 is moved or deflected to release the kicker lever 140 from the unlatched position. In this way, when operating the slider 160 to close the contacts 130, 132, the slider 160 is sufficiently clear from the kicker lever 140 so that the blade 120 is allowed to freely snap to the closed-contacts position, under at least force of the extension spring.

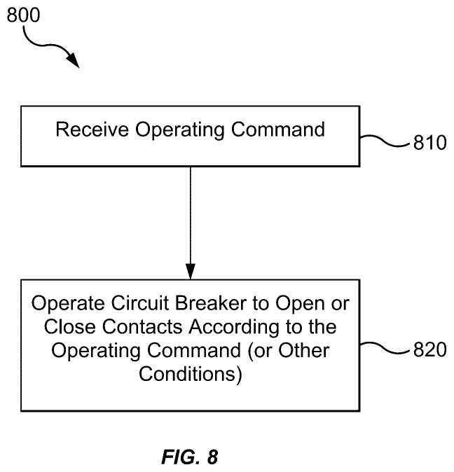

FIG. 7 shows an example slider 160 of the circuit breaker 100 of FIGS. 1-4, according to embodiments of the present disclosure. As shown, the slider 160 can include a first side 700 and a second side 702 which can be opposite the first side 700. The slider 160 can include a base 710 at the first side 700. The base 710 can be operatively coupled or connected to the motor 180, such as for example across a gear assembly or box. In this example, the motor 180 can be operatively connected or coupled to the base 710 of the slider 160, across at least a worm gear (e.g., 170) which can have a portion thereof ride along a region 720 of the base 710 of the slider 160. The region 720 can be a recessed region configured with suitable dimensions to engage the worm gear to facilitate linear movement of the slider 160 in one direction and in an opposite direction according to the operation of the motor 180.

Furthermore, the slider 160 also can include a slider extension 750 (e.g., extending arm, extending leg, extending member, etc.) which extends from the base 710 to an open end at the second side 702. The slider extension 750 can include a plurality of contact surface regions, including at least a first contact surface region 752 and a second contact surface region 754. The slider extension 750 can extend as a step, step-wise manner, or the like from the base 710 (along a length of the slider 160), and provide an open region or area below the slider extension 750 for the catch lever 150 or component(s) thereof when housed in the circuit breaker 100.

The first contact surface region 752 of the slider extension 750 is configured to engage the kicker lever 140 when the circuit breaker 100 is operated via the slider 160 to the opened-contacts position, and to disengage from the kicker lever 140 when the circuit breaker 100 is operated via the slider 160 to the closed-contacts position.

The second surface contact region 754 of the slider extension 750 is configured to disengage from the deflection surface region 622 of the catch lever 150 and allow the catch lever 150 to move or return to the undeflected position when the circuit breaker 100 is operated via the slider 160 to the opened-contacts position, and to engage the deflection surface region 622 of the catch lever 150 and to move or deflect the catch lever 150 to the deflected position when the circuit breaker 100 is operated via the slider 160 to the closed-contacts position. In this example, the second contact surface region 754 can include at least ramping (or ramped) surface (or region thereof), which is provided or located at a bottom or bottom side of the slider extension 750 at or in proximity to the open end of the slider extension 750.

In various embodiments, the second contact surface region 754 of the slider extension 750 can be configured in a predefined relationship to the first contact surface region 752 of the slider extension 75 by dimension and/or distance to allow for snap closing of the first and second electrical contacts, which is free from interference or influence by the slider 160, as the slider 160 is operated in the second direction away from the kicker lever 140.

In various embodiments, the slider 160 can be configured to move linearly along a longitudinal axis in either the first or second direction. The slider extension 750 can extend lengthwise or along the longitudinal axis from the base 710 of the slider 160.

FIG. 8 is a flow chart of an example process 800 of operating a circuit breaker between various operational positions, including an opened-contacts position and a closed-contacts position. For the purposes of example discussion, the process 800 will be described with reference to components of the example circuit breaker 100 of FIGS. 1-4. For example, the process 800 or operations thereof can be implemented by or under control of a controller(s) (e.g., 190) of the circuit breaker, which can be a single-pole or multi-pole circuit breaker.

At block 810, the circuit breaker 100 receives an operating command (or signal). In various embodiments, the operating command can be received locally via a user interface of the circuit breaker 100, or remotely from a remote device or system over wireline or wireless communications. The remote device can be an unintelligent device or an intelligent device, including a user device (e.g., smartphone, computer tablet, computer, etc.).

At block 820, the circuit breaker 100 is operated to open or close the electrical contacts according to the operating command. For example, in various embodiments, the controller 190 of the circuit breaker 100 can control the operation of the slider 160, via the motor 180, to selectively open or close the electrical contacts according to the operating command received by the controller 190. In various embodiments, the controller 190 can operate, via the motor 180, the slider 160 in the first direction to open the contacts 130, 132 of the circuit breaker 100 in the opened-contacts position, and in the second direction to close the contacts 130, 132 of the circuit breaker 100 in the closed-contacts position. The second direction can be a direction, which is opposite the first direction.

In various embodiments, the circuit breaker 100 also can operate the opening or closing of the electrical contacts according to detected conditions on the circuit breaker or on the protected circuit. The conditions can be detected using one or more sensors, and can including, for example, diagnostic conditions, fault or overload conditions, etc.

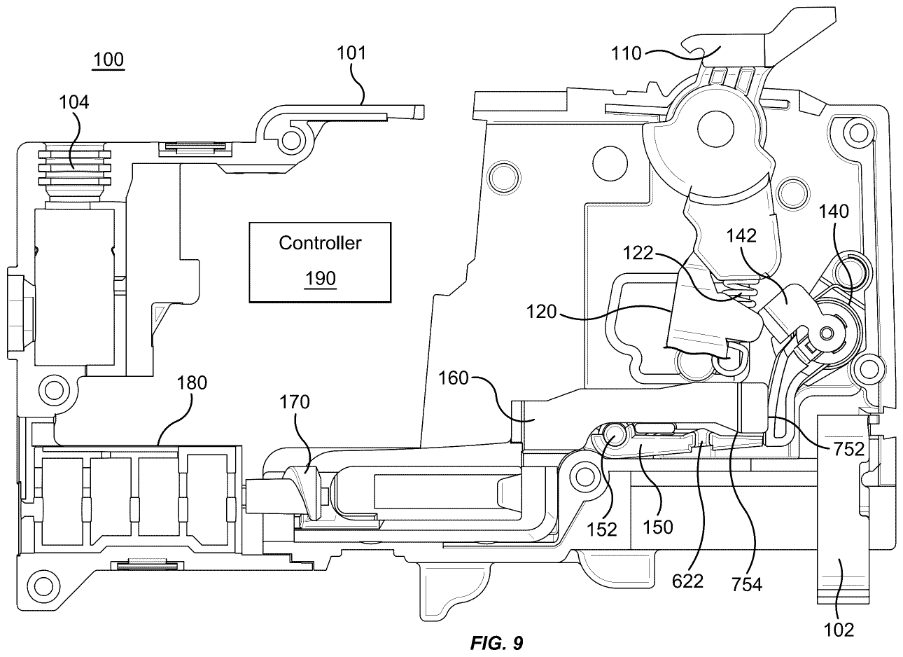

FIGS. 9, 10 and 11 show side views of example components of the circuit breaker of FIG. 1, with a portion of the blade 120 and contacts 130, 132 omitted, in the opened-contacts position, the intermediate-opened-contacts position and the closed-contacts position, respectively, according to embodiments of the present disclosure. Example operations of closing or opening of the contacts of the circuit breaker 100 will be described with reference to FIGS. 9-11.

For example, as shown in FIG. 9, the circuit breaker 100 is in the opened-contacts position, with the contacts 130, 132 opened (e.g., in the open position). In the opened-contacts position, the slider 160 can have the first contact surface region 752 engaged against the kicker lever 140, and the second contact surface region 754 disengaged from the deflection surface region 622 of the catch lever 150 to catch and retain the kicker lever 140 in the latched position. In the latched position, the kicker 142 of the kicker lever 140 is engaged against the blade 120 or portion thereof to move and retain the blade 120 and its contact 130 in the opened-contacts position (see also FIGS. 1 and 2).

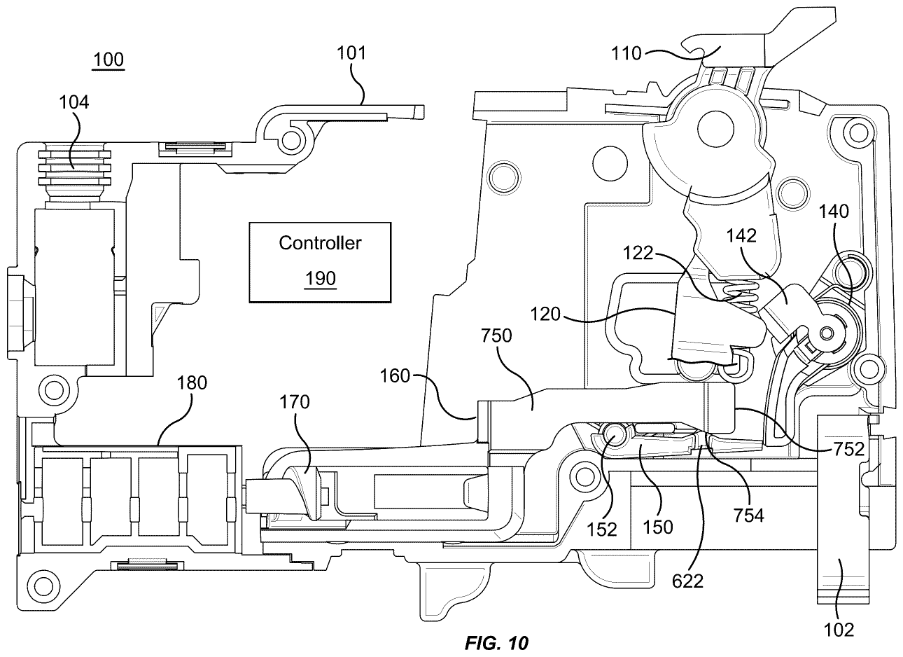

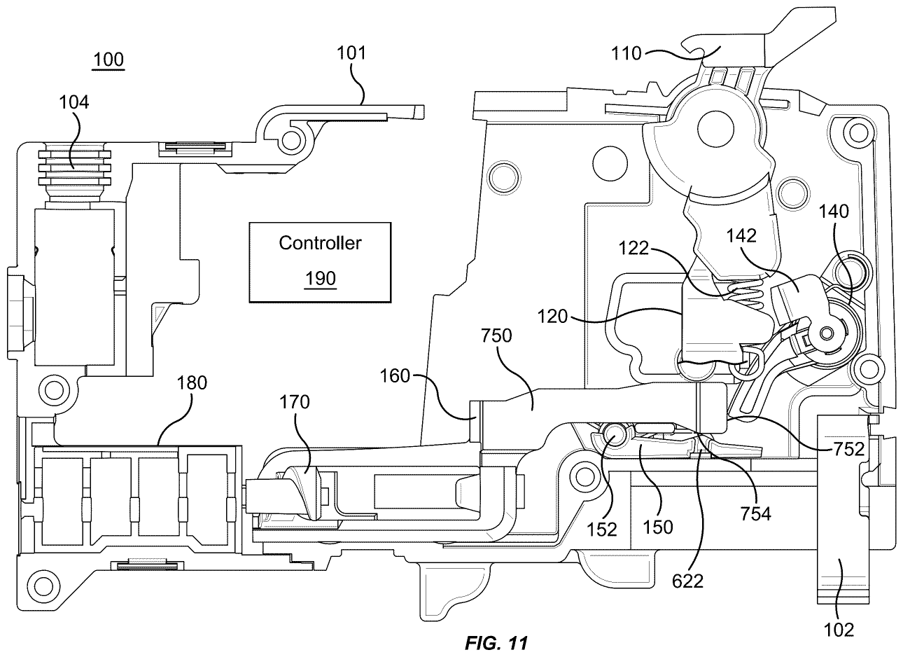

To operate the circuit breaker 100 from the opened-contacts position to the closed-contacts position, the slider 160 can be operated via the motor 180 to move in a direction away from the kicker lever 140. As shown in FIG. 10, as the slider 160 moves away from the kicker lever 140, the slider 160 begins to disengage and separate from the kicker lever 140 to an intermediate opened-contacts position. In FIG. 10, the deflection surface region 622 of the catch lever 150 is also shown as making contact with the ramp region of the second contact surface region 754 of the slider extension 750 of the slider 160. Turning to FIG. 11, as the slider 160 continues to move away from the kicker lever 140 from the intermediate opened-contacts position to the closed-contacts position, the catch lever 150 is sufficiently deflected or moved (by the interaction of the second contact surface region 754 of the slider 160 and the deflection surface region 622 of the catch lever 150) to disengage from the kicker lever 140, thereby unlatching and releasing the kicker lever 140 from the latched position to the unlatched position. In the unlatched position, the kicker lever can freely move in a direction, which disengages and releases the kicker 142 from the blade 120 (or a portion thereof). The released blade 120 thereafter can snap and close the contacts 130, 132 in the closed-contacts position under the force supplied from the extension spring (e.g., the toggle spring 122). As shown in the transition from the intermediate opened-contacts position of FIG. 10 to the closed-contacts position of FIG. 11, the interrelationship between the kicker lever 140, catch lever 150 and the slider 160 are configured to provide a sufficient clearance between the slider 160 and the kicker lever, when the blade 120 is released in order to facilitate fast, snapping closure of the contacts 130, 132 in a single motion. In this way, the slider 160 or any other components do not interfere with the snap closing operation of the released blade 120 under the force of the extension spring (e.g., toggle spring 122).

The above describes an example contacts-closing operation of the circuit breaker 100. In various embodiments, the slider 160 can be operated in the reverse direction, via the motor, to operate the circuit breaker 100 from the closed-contacts position (as shown in FIG. 11) to the opened-contacts position (as shown in FIG. 9) where the contacts 130, 132 are opened and the extension spring for the blade (e.g., the toggle spring 122) has reached an armed position. For example, the slider 160 can be operated in a direction to move toward the kicker lever 140 in order to engage and push/move the kicker lever 140 (e.g., via the first contact surface region of the slider 160), which in turn pushes/moves the kicker 142 to engage and move the blade 120 to separate the contacts 130, 132. Furthermore, as the slider 160 is moved from the closed-contacts position (as shown in FIG. 11) to the opened-contacts position, the catch lever 150 is moved from the deflected position to the undeflected position where the catch lever 150 can catch and retain the kicker lever 140 in the latched position with the contacts 130, 132 opened, as shown in FIG. 9.

It is understood that embodiments of the disclosure herein may be configured as a system, method, or combination thereof. Accordingly, embodiments of the present disclosure may be comprised of various means including hardware, software, firmware or any combination thereof.

It should also be understood that the example embodiments disclosed and taught herein are susceptible to numerous and various modifications and alternative forms. Thus, the use of a singular term, such as, but not limited to, “a” and the like, is not intended as limiting of the number of items. Furthermore, the naming conventions for the various components, functions, characteristics, thresholds, and other elements used herein are provided as examples, and can be given a different name or label. The use of the term “or” is not limited to exclusive “or”, but can also mean “and/or”.

It will be appreciated that the development of an actual, real commercial application incorporating aspects of the disclosed embodiments will require many implementation specific decisions to achieve the developer's ultimate goal for the commercial embodiment. Such implementation specific decisions may include, and likely are not limited to, compliance with system related, business related, government related and other constraints, which may vary by specific implementation, location and from time to time. While a developer's efforts might be complex and time consuming in an absolute sense, such efforts would nevertheless be a routine undertaking for those of skill in this art having the benefit of this disclosure.

Using the description provided herein, the example embodiments may be implemented as a machine, process, or article of manufacture by using standard programming and/or engineering techniques to produce programming software, firmware, hardware, or any combination thereof.

Any resulting program(s), having computer-readable program code, may be embodied on one or more tangible or non-transitory computer-usable media such as resident memory devices, smart cards or other removable memory devices, or transmitting devices, thereby making a computer program product or article of manufacture according to the embodiments. As such, the terms “article of manufacture” and “computer program product” as used herein are intended to encompass a computer program that exists permanently or temporarily on any computer-usable or storage medium or in any transmitting medium which transmits such a program.

A processor(s), controller(s) or processing unit(s) as described herein can be a processing system, which can include one or more processors, such as CPU, controllers, ASICs, or other processing units or circuitry, which controls or performs the operations of the devices or systems, described herein. Memory/storage devices can include, but are not limited to, disks, solid state drives, optical disks, removable memory devices such as smart cards, SIMs, WIMs, semiconductor memories such as RAM, ROM, PROMS, etc. Transmitting mediums or networks can include, but are not limited to, transmission via wireline communication, wireless communication (e.g., Radio Frequency (RF) communication, Bluetooth®, Wi-Fi, Li-Fi, etc.), the Internet, intranets, telephone/modem-based network communication, hard-wired/cabled communication network, satellite communication, and other stationary or mobile network systems/communication links.

The flowchart and block diagrams in the Figures illustrate the architecture, functionality and/or operation of possible implementations of various embodiments of the present disclosure. In this regard, each block in the flowchart or block diagrams may represent a module, segment or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While particular embodiments and applications of the present disclosure have been illustrated and described, it is to be understood that the present disclosure is not limited to the precise construction and compositions disclosed herein and that various modifications, changes, and variations can be apparent from the foregoing descriptions without departing from the invention as defined in the appended claims. It is understood that components, features and functionality in various embodiments as described herein can be incorporated into other embodiments.

While several embodiments of the present disclosure have been shown and described herein, it is to be understood that the above description is intended to be illustrative, and not restrictive. Many other implementation examples are apparent upon reading and understanding the above description. Although the disclosure describes specific examples, it is recognized that the systems and methods of the disclosure are not limited to the examples described herein, but may be practiced with modifications within the scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

I/We claim:

1. A circuit breaker, comprising:
a moveable blade having a first electrical contact thereon or attached thereto, which is configured to make contact with a second electrical contact in a closed-contacts position and to be separated from the second electrical contact in an opened-contacts position;
a moveable kicker lever, which includes or is connected to a kicker, being operable to engage and move the blade via the kicker to open the first and second electrical contacts when operated to the opened-contacts position or to release the blade from the opened-contacts position to allow the first and second electrical contacts to close when operated to the closed-contacts position;
a moveable catch lever being operable to a latched position for catching and retaining the kicker lever in the opened-contacts position and an unlatched position for unlatching and releasing the kicker lever, which in turn releases the blade via the kicker, from the opened-contacts position to the closed-contacts position; and
a moveable slider being moveable in a first direction and a second direction which is opposite the first direction, the slider being operable:
in the first direction to engage and move the kicker lever, via one end of the slider, to the opened-contacts position and to cause the catch lever to move to the latched position, the catch lever or a portion thereof being arranged below or under the slider, and
in the second direction to disengage the one end of the slider from the kicker lever, and after separation, to cause the catch lever to move to the unlatched position for releasing the kicker lever, which in turn releases the blade via the kicker, from the opened-contacts position to the closed-contacts position, thereby allowing the blade to snap close the first and second electrical contacts under a force from an extension spring attached to the moveable blade.

2. The circuit breaker according to claim 1, wherein the slider is configured to move linearly along a longitudinal axis in either the first or second direction, a slider extension of the slider extending lengthwise or along the longitudinal axis from the base of the slider.

3. The circuit breaker according to claim 1, further comprising a housing for housing components of the circuit breaker,
wherein the slider has a first end and a second end opposite the first end, a base of the slider is configured to be connected, directly or indirectly, to a motor at the first end, and a slider extension of the slider extends from the base to the one end at the second end and provides an open region below the slider extension for the catch lever or portion thereof when housed in the housing.

4. The circuit breaker according to claim 3, wherein the slider extension comprises an arm, which extends in a step-wise manner from the base to provide for the open region.

5. The circuit breaker according to claim 1, wherein the catch lever is pivotable and includes a pivoting end and an open end opposite the pivoting end, the open end of the catch lever being configured to catch and retain the kicker lever in the latched position when the slider is moved in the first direction.

6. The circuit breaker according to claim 5, wherein the catch lever is biased by a biasing force to move toward the slider or extension thereof.

7. The circuit breaker according to claim 5, further comprising a pivot pin about which the pivoting end of the catch lever pivots, the slider or extension thereof being supported or guided by the pivot pin when moving in the first or second direction.

8. The circuit breaker according to claim 5, wherein the kicker lever includes a pivoting end and an open end opposite the pivoting end, and the open end of the catch lever is configured to engage the open end of the kicker lever in the latched position.

9. The circuit breaker according to claim 8, wherein a tip of the open end of the catch lever is configured to engage the open end of the kicker lever in the latched position.

10. The circuit breaker according to claim 1, wherein the slider or extension thereof includes first and second contact surface regions, the first contact surface region is located on the one end of the slider or extension thereof and is configured to engage or disengage from the kicker lever, and the second contact surface region is located on a bottom side of the slider or extension thereof facing the catch lever or a portion thereof and comprises at least a ramped surface region for engaging or disengaging from the catch lever.

11. The circuit breaker according to claim 10, wherein the catch lever includes a deflection surface region or protrusion which is configured to engage and ride along the ramped surface region of the second contact surface region of the slider or extension thereof, when the slider is moved in the second direction, to move or pivot the catch lever from the latched position to the unlatched position for unlatching and releasing the kicker lever from the opened-contacts position to the closed-contacts position.

12. The circuit breaker according to claim 11, wherein the second contact surface region of the slider or extension thereof is configured in a predefined relationship to the first contact surface region of the slider or extension thereof by dimension and/or distance to allow for snap closing of the first and second electrical contacts, which is free from interference or influence by the slider, as the slider is operated in the second direction.

13. The circuit breaker according to claim 1, wherein the kicker lever includes a base and a kicker-lever extension which extends from the base to an open end, the catch lever includes a base and a catch extension which extends from the base to an open end, and a tip of the open end of the catch lever, which is below the one end of the slider, engages the open end of the kicker lever in the latched position.

14. The circuit breaker according to claim 1, wherein, when the slider is moved in the first direction, the one end of the slider or extension thereof is configured to engage an open end of the kicker lever and move the kicker, which in turn moves the blade, from the closed-contacts position to the opened-contacts position.

15. The circuit breaker according to claim 1, further comprising:
a motor, operatively connected to the slider, for moving the slider in the second direction;
a communication device for communicating with a remote device; and
a controller configured to:
receive a command from the remote device via the communication device, and
in response to the command, control the motor to release the slider so it can move in the first direction to operate the blade to the opened-contacts position or move the slider in the second direction to operate the blade to the closed-contacts position.

16. The circuit breaker according to claim 1, wherein the circuit breaker is a multi-pole circuit breaker.

17. The circuit breaker according to claim 16, wherein each pole of the circuit breaker includes a motorized subsystem, each of the motorized subsystems including the blade, the kicker lever and kicker, the catch lever, and the slider.

18. An assembly for a circuit breaker, comprising:
a moveable kicker lever, which includes or is connected to a kicker, being operable to engage and move a blade of the circuit breaker via the kicker to open electrical contacts of the circuit breaker when operated to an opened-contacts position or to release the blade from the opened-contacts position to allow the electrical contacts to close when operated to a closed-contacts position;
a moveable catch lever being operable to a latched position for catching and retaining the kicker lever in the opened-contacts position and an unlatched position for unlatching and releasing the kicker lever, which in turn releases the blade via the kicker, from the opened-contacts position to the closed-contacts position; and
a moveable slider being moveable in a first direction and a second direction which is opposite the first direction, the slider being operable:
in the first direction to engage and move the kicker lever, via one end of the slider, to the opened-contacts position and to cause the catch lever to move to the latched position, the catch lever or a portion thereof being arranged below or under the slider, and
in the second direction to disengage the one end of the slider from the kicker lever, and after separation, to cause the catch lever to move to the unlatched position for releasing the kicker lever, which in turn releases the blade via the kicker, from the opened-Docket contacts position to the closed-contacts position, thereby allowing the blade to snap close the electrical contacts.

19. The assembly according to claim 18, wherein the slider or extension thereof includes first and second contact surface regions, the first contact surface region is located on the one end of the slider or extension thereof and is configured to engage or disengage from the kicker lever, and the second contact surface region is located on a bottom side of the slider or extension thereof facing the catch lever or a portion thereof and comprises at least a ramped surface region for engaging or disengaging from the catch lever.

20. A method of operating an assembly for a circuit breaker, comprising:
operating a moveable kicker lever, which includes or is connected to a kicker, to engage and move a blade of the circuit breaker via the kicker to open electrical contacts of the circuit breaker when operated to an opened-contacts position or to release the blade from the opened-contacts position to allow the electrical contacts to close when operated to a closed-contacts position;
operating a moveable catch lever to a latched position for catching and retaining the kicker lever in the opened-contacts position or an unlatched position for unlatching and releasing the kicker lever, which in turn releases the blade via the kicker, from the opened-contacts position to the closed-contacts position; and
operating a moveable slider being moveable in a first direction and a second direction which is opposite the first direction, the slider being operable:
in the first direction to engage and move the kicker lever, via one end of the slider, to the opened-contacts position and to cause the catch lever to move to the latched position, the catch lever or a portion thereof being arranged below or under the slider, and
in the second direction to disengage the one end of the slider from the kicker lever, and after separation, to cause the catch lever to move to the unlatched position for releasing the kicker lever, which in turn releases the blade via the kicker, from the opened-contacts position to the closed-contacts position, thereby allowing the blade to snap close the electrical contacts.
